(19) United States
(12) Patent Application Publication
(10) Pub. No.: US 2008/0309852 A1
(43) Pub. Date: Dec. 18, 2008

(54) System and Method for Creating a Mirror Effect in a Liquid Crystal Display

(75) Inventor: Eugene Murphy O'Donnell, Fishers, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/159,914

(22) PCT Filed: Jan. 5, 2006
(86) PCT No.: PCT/US06/00489

§ 371 Date: Jul. 2, 2008

(51) Int. Cl. G02F 1/1333; G02F 1/1335; G02F 1/13

(52) U.S. Cl. 349/74; 349/96; 349/187

(57) ABSTRACT

The disclosed embodiments relate to a system and method for creating a mirror effect in a liquid crystal display. More specifically, in one embodiment, there is provided a display device comprising a first absorptive polarizer, a first liquid crystal arrayed adjacent to the first absorptive polarizer, a second absorptive polarizer arrayed adjacent to the first liquid crystal, wherein the second absorptive polarizer is cross polarized with the first absorptive polarizer, a reflective polarizer arrayed adjacent to the second absorptive polarizer, a second liquid crystal arrayed adjacent to the reflective polarizer, and a third absorptive polarizer arrayed adjacent to the second liquid crystal, wherein the third absorptive polarizer is cross polarized with respect to the reflective polarizer.

### FIELD OF THE INVENTION

The present invention relates generally to liquid crystal displays (“LCDs”). More specifically, the present invention is related to a system and method for creating a mirror effect in an LCD.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

As most people are aware, liquid crystal displays (“LCDs”) are employed in a wide variety of electronic devices to display information, data, pictures, video, and so forth. One of the more popular uses for LCDs over the past few years has been in flat panel televisions and computer displays. Unlike conventional cathode ray televisions which are typically large and fairly heavy, flat panel televisions may be less than four inches thick and relatively light weight.

Although once limited mainly to use in place of cathode ray televisions, flat panel displays have recently begun to find uses in places where it is impractical to use a cathode ray television. For example, because flat panel displays can be mounted or hung on a wall, some people have begun to use flat panel displays in the place of picture frames or artwork. More particularly, a flat panel display may be hung on a wall and configured to display a famous work of art or a family photograph when the flat panel display is not being used as a television. In this way, the flat panel display can provide dual uses as both an appliance and as a decoration.

Another potential dual use of flat panel displays is as a video display and a mirror. There are numerous advantages, both commercial and residential, to a flat panel display that can switch between a video display mode and a mirror mode. For example, this type of flat panel television could be used in bathrooms, changing rooms, or other public areas to provide both a mirror and a video display in a single unit. Further, this type of display unit would also have a variety of residential uses (e.g., a living room or bathroom mirror that also functioned as a television or a computer monitor).

Unfortunately, conventional systems for creating a mirrored surface on a flat panel display have several disadvantages. Foremost amongst these disadvantages is that adding a conventional mirrored surface to a flat panel display causes a loss of contrast when the flat panel television is used to display video images. More specifically, as the reflectivity of a mirrored surface within the flat panel display increases, the amount of ambient light contamination of the video image on the screen increases. Amongst other things, this increase in ambient light contamination can degrade the contrast of the video of the video image, especially with regard to darker colors, such as black.

An improved system and method for creating a mirrored effect in an LCD display unit is desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method for creating a mirror effect in a liquid crystal display. More specifically, in one embodiment, there is provided a display device comprising a first absorptive polarizer, a first liquid crystal arrayed adjacent to the first absorptive polarizer, a second absorptive polarizer arrayed adjacent to the first liquid crystal wherein the second absorptive polarizer is cross polarized with the first absorptive polarizer, a reflective polarizer arrayed adjacent to the second absorptive polarizer, a second liquid crystal arrayed adjacent to the reflective polarizer, and a third absorptive polarizer arrayed adjacent to the second liquid crystal, wherein the third absorptive polarizer is cross polarized with respect to the reflective polarizer.

### BRIEF DESCRIPTION OF THE DRAWINGS

Advantages of the invention may become apparent upon reading the following detailed description and upon reference to the drawings in which:

FIG. 1 is a block diagram of an exemplary display unit in accordance with one embodiment;

FIG. 2 is a cross sectional view of an exemplary LCD assembly in accordance with one embodiment; and

FIG. 3 is a flow chart illustrating an exemplary technique for creating a mirror effect in an LCD in accordance with one embodiment.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The embodiments described herein relate to a system and method for creating a mirror effect in a liquid crystal display (“LCD”). More specifically, in one embodiment, a plurality of polarizer's and two liquid crystal (“LC”) assemblies are employed to create a display unit capable of functioning as both a video or computer display unit and as a mirror. This embodiment is configured to provide the mirror effect at a relatively low incremental cost and with relatively high contrast.

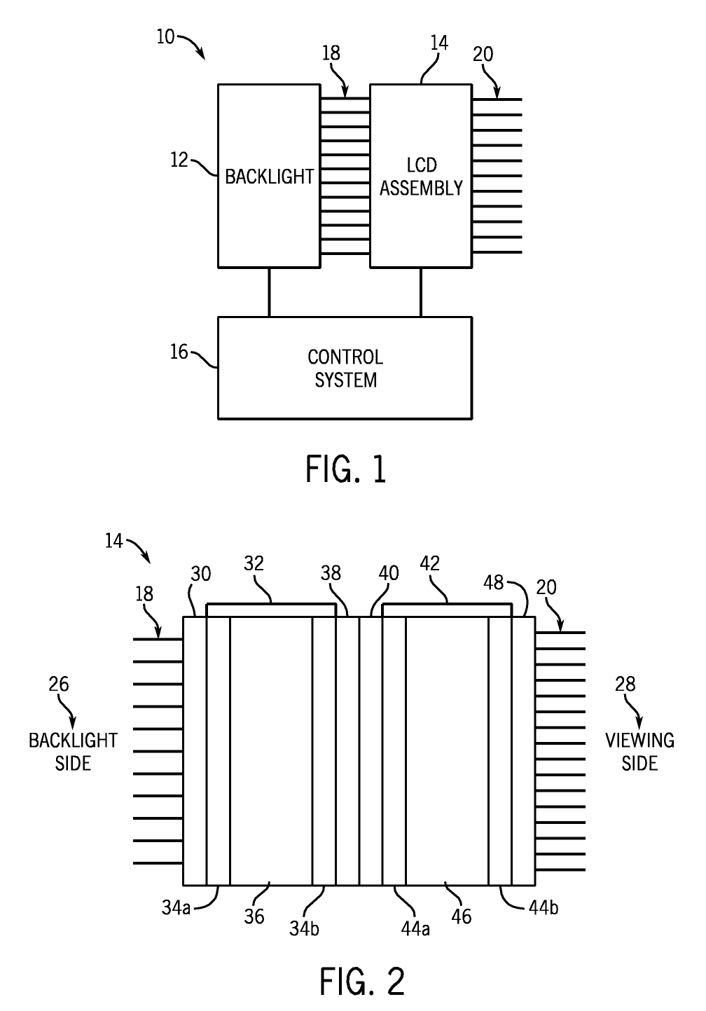

Turning now to the figures, and looking first at FIG. 1, a block diagram of an exemplary display unit in accordance with one embodiment is illustrated and generally designated by a reference numeral 10. As illustrated in FIG. 1, the display unit 10 may include a backlight 12, an LCD assembly 14, and a control system 16. It will be appreciated, however, that the embodiment illustrated in FIG. 1 is merely one potential embodiment of the display unit 10. As such, in alternate embodiments, the display unit 10 may include other suitable elements or may not include one of more of the elements illustrated in FIG. 1.

LCDs, such as the LCDs located in the LCD assembly 14, create images by manipulating visible ambient light. LCDs do not, however, typically create light. As such, the display unit 10 may include the backlight 12 to generate some or all of the light 18 that the LCD assembly may employ to create the images displayed on the LCD assembly 14. The backlight 12 may include any suitable form of LCD backlighting. For example, the backlight 12 may include one or more light emitting diodes (“LEDs”), an electroluminescence panel (“ELP”), a cold cathode florescent lamp (“CCFL”), a woven fiber optical mesh, and/or an incandescent lamp. Those of ordinary skill in the art, however, will appreciate that these types of backlighting are merely exemplary. As such, in alternate embodiments, the backlight 12 may include other suitable forms of backlighting. Moreover, in still other embodiments, the backlight 12 may be omitted from the display unit 10, and the ambient light used to create an image on the LCD assembly 14 may be provided from another source. For example, the light used to create an image on the LCD assembly 14 may be provided by a light source on the side or in front of the LCD assembly 14.

As described above, the display unit 10 may also include the LCD assembly 14. As will be described in greater detail below with regard to FIG. 2, the LCD assembly 14 may be configured to alternate between a video display mode and a mirror mode based on control signals and/or voltages supplied by the control system 16. For example, while in the video mode, the LCD may be configured to generate light 20 that embodies display video images from a television, satellite dish, cable connection, computer, or other suitable source, in much the same way that conventional LCDs function. While in the mirror mode, however, the LCD assembly 14 (and, indeed the entire display unit 10), is configured to appear to an observer as a mirrored surface (in other words, to reflect up to 50% of the light entering the LCD assembly 14 as the light 20. In some embodiments, the appearance of the display unit 10 while in the mirror mode may be virtually indistinguishable from a conventional household mirror.

Lastly, the display unit 10 may include the control system 16. The control system 16 may be configured to perform a wide variety of suitable functions within the display unit 10. For example, as described in more detail below, the control system 16 may be configured to switch the LCD assembly 14 between a mirror mode and a video display mode by applying a voltage to the LCD assembly 14. In one embodiment, the control system may be configured to automatically apply the voltage, such as in response to a sleep timer. Whereas, in another embodiment, the control system 16 may apply the voltage to the LCD assembly in response to a user command. As such, the control system 16 may also be configured to receive user commands via a remote control, a control panel, and/or some other suitable source directing the display unit 10 to change modes.

In addition, the control system 16 may also be configured to perform a wide variety of other control or display functions within the display unit 10. For example, the control system 16 may be configured to receive video programming, computer display information, or other suitable types of images and to transmit these images to the LCD assembly 14 for display. Those of ordinary skill in the art will appreciate that the above-described functions of the control unit 16 are not intended to be exclusive. As such, in alternate embodiments, the control system 16 may be configured to perform a wide variety of other suitable functions within the display unit 10.

As described above, the components of the LCD assembly 14 enable the LCD 14 to switch between a mirror mode and a video display mode. FIG. 2 is presented to more thoroughly describe this functionality. FIG. 2 is a cross-sectional view of the LCD assembly 14 in accordance with one embodiment. As illustrated in FIG. 2, the LCD assembly 14 may include a plurality of polarizer's and LC assemblies arrayed between a backlit side 26 and a viewing side 28 of the LCD assembly 14. As illustrated, an absorptive polarizer 30 may be arrayed on the backlight side 26. In one embodiment, the absorptive polarizer 30 may be a HLC2-5618 polarizer produced by Sanritz.

Adjacent to the absorptive polarizer 30, a display LC assembly 32, including a display LC 36 with a thin film transistor (“TFT”) matrix arrayed between LC cover glass and electrodes 34a and 34b, may be arrayed. Next, another absorptive polarizer 38 may be arrayed adjacent to the display LC assembly 32. The absorptive polarizer 38 may be approximately cross polarized with the absorptive polarizer 30. A reflective polarizer 40 may be arrayed adjacent to the absorptive polarizer 38 with an orientation in parallel with the absorptive polarizer 38 (i.e., cross with respect to the absorptive polarizer 30). In one embodiment, the absorptive polarizer 38 may be a HLC2-5618 polarizer produced by Sanritz, and the reflective polarizer 40 may be a DBEF-P2 polarizer produced by 3M.

Continuing through the LCD assembly 14 towards the viewing side 28, a single cell LC assembly 42, including a single cell LC 46 between LC cover glass and electrodes 44a and 44b may be arrayed adjacent to the reflective polarizer 40. In alternate embodiments, more complex LCs may be employed in place of the single cell LC 46. For example, a dual cell LC, a three cell LC, and so forth may be employed in place of the single cell LC 46. Lastly, an absorptive polarizer 48 may be arrayed adjacent to the single cell LC assembly 42. The absorptive polarizer 48 may be arrayed in an orientation such it is cross polarized with respect to the absorptive polarizer 38 and the reflective polarizer 40. In one embodiment, the absorptive polarizer 38 may be a HLC2-5618 polarizer produced by Sanritz.

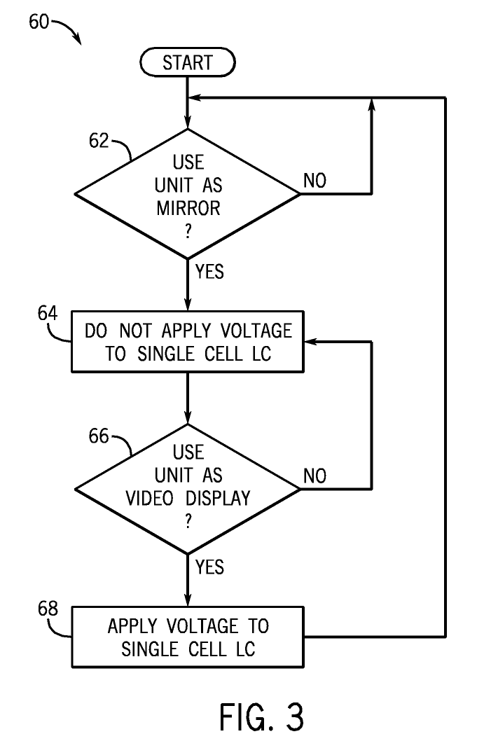

Next, the operation of the display unit 10 will be examined in conjunction with FIG. 2 and FIG. 3, a flow chart illustrating an exemplary technique 60 for creating a mirror effect in an LCD in accordance with one embodiment. In one embodiment, the technique 60 may be executed by the control system 18. As those of ordinary skill in the art will appreciate, the crystals within a liquid crystal, such as a single cell LC 46, are able to vary their treatment of incoming light based the presence or absence of a voltage. More specifically, in one embodiment, when a voltage is applied to the single cell LC assembly 42, the single cell LC 46 may be configured to adjust the phase (i.e., the polarity) of incoming light by approximately 90 degrees; whereas if no voltage is applied, light will pass through the single cell LC 46 without a change of phase. It will be appreciated, however, that in alternate embodiments, the single cell LC 46 may be configured to work in the opposite manner. In other words, the single cell LC may be configured to adjust the phase angle of incoming light by 90 degree when no voltage is applied and vice-versa.

The switching voltage of the single cell LC 46 depends on LC type used to create the single cell LC 46. In one embodiment, a Vertically Aligned Nematic (VAN) LC may be employed due to its high contrast. Typical switching voltages for a VAN LC are in the range of 5-7 volts rms range (depending on the LC mode, material, and cell gap).

Accordingly, if the display unit 10 is to be used as a mirror (block 62 of FIG. 3), the control system 16 is configured to apply little or no voltage to the single cell LC 46 (see block 64). Because no voltage has been applied to the single cell LC 46, the single cell LC 46 will not change the polarity of incoming light. As such, because the absorptive polarizer 48 is crossed versus the reflective polarizer 40, half the incoming light from the viewing side 28 will be absorbed by the absorptive polarizer 48 while the other half passed through the single cell LC assembly 42 without a change in phase, and is reflected off the reflective polarizer 40 back through the single cell assembly 42 (still without a change in phase) and the absorptive polarizer 48. In this way, the LCD assembly 14 essentially reflects approximately fifty percent of the light entering the LCD assembly 14 when the LCD assembly 14 is in the mirror mode (i.e., when no voltage is applied to the single cell LC assembly 42.)

On the other hand, if the LCD assembly is operating in the video display mode (block 66 of FIG. 3), a voltage may be applied to the single cell LC assembly 42 such that the single cell LC 46 produces a ninety degree phase shift in light entering the single cell LC 46 (block 68 of FIG. 103). This phase shift allows light generated by the display LC 36 assembly 32 to pass through the absorptive polarizer 48. In other words, when the LCD assembly 14 is in the video display mode, the light from the display LC assembly 32, which is configured to pass through the absorptive polarizer 38 and the reflective polarizer 40, will also be able to pass through the absorptive polarizer 48. More specifically, even though the absorptive polarizer 48 is crossed versus the absorptive polarizer 38 and the reflective polarizer 40, the single cell LC assembly 42, when powered, will change the phase of the light passing through it by ninety degrees. As such, light generated by the display LC assembly 32 (e.g., a graphical image) will pass through to the viewing side 28 where it can be viewed.

Further, due to the configuration of the LCD assembly 14, light entering the LCD assembly 14 from the viewing side 20 will not degrade the contrast of the display unit 10. More particularly, light that enters the LCD assembly from the viewing side 28 will be partially absorbed by the absorptive polarizer 48 (as described above, this polarizer absorbs approximately fifty percent of incoming light). The remaining light will be undergo a ninety degree change of phase from the single cell LC assembly 42, and will, thus, be able to pass through both the reflective polarizer 40 and the absorptive polarizer 38. As such, the display unit 10 does not create a mirror effect when it is in the video display mode.

After the light passes through the polarizers 38 and 40, it will enter the LC assembly 32. If a particular pixel on the display assembly LC 36 is “white,” (i.e., the display LC 36 is introducing a phase shift for that pixel), the light will continue through the absorptive polarizer and pass into the backlight side of the LCD assembly 14 and add to the overall brightness of the video image being displayed by the display unit 10. If, on the other hand, a particular display pixel is “black,” (i.e., the display LC 36 is not adjusting the phase of that particular pixel), then the incoming light at that pixel location will be absorbed by the absorptive polarizer 30, as the absorptive polarizer 30 is crossed with the polarizers 38 and 40. In this way, the LCD assembly 14 is able to maintain a high contrast regardless of the amount of ambient light entering the LCD assembly 14 from the viewing side 28.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A display device comprising:
a first absorptive polarizer;
a first liquid crystal arrayed adjacent to the first absorptive polarizer;
a second absorptive polarizer arrayed adjacent to the first liquid crystal, wherein the second absorptive polarizer is cross polarized with the first absorptive polarizer;
a reflective polarizer arrayed adjacent to the second absorptive polarizer;
a second liquid crystal arrayed adjacent to the reflective polarizer; and
a third absorptive polarizer arrayed adjacent to the second liquid crystal, wherein the third absorptive polarizer is cross polarized with respect to the reflective polarizer.

2. The display device of claim 1, wherein the second liquid crystal is a single cell liquid crystal.

3. The display device of claim 2, wherein the second liquid crystal comprises a Vertically Aligned Nematic liquid crystal.

4. The display device of claim 1, comprising a backlight configured to project light into the first absorptive polarizer.

5. The display device of claim 1, comprising a control system configured to apply a voltage to the second liquid crystal to cause the display device to switch from a mirror mode to a video display mode.

6. The display device of claim 5, wherein the control system is configured to remove the voltage to cause the display device to switch from the video display mode to the mirror mode.

7. The display device of claim 5, wherein the control system is configured to accept user commands indicative of either the video display mode or the mirror mode.

8. The display device of claim 1, wherein the second liquid crystal is configured to adjust the phase of light by approximately 90 degrees with a voltage is applied to the second liquid crystal.

9. The display device of claim 1, wherein the display device comprises a liquid crystal display television.

10. A method of managing light in a display unit, the method comprising:
polarizing incoming light;
shifting the phase of the polarized light by approximately ninety degrees if the display unit is in a first state;
if the display unit is in a second state, reflecting the polarized light; and
if the display unit is in the first state, passing the phase-shifted light through a plurality of pixel locations in a first liquid crystal;

11. The method of claim 10, comprising:
shifting the phase of the phase-shifted light by approximately ninety degree; and
absorbing the phase-shifted light.

12. The method of claim 10, comprising passing the phase-shifted light into a backlit region of the display unit.

13. The method of claim 10, comprising applying a voltage to a second liquid crystal if the display unit is in the first state, wherein the second liquid crystal is configured shifting the phase of the polarized light by approximately ninety degrees when the voltage is applied to the second liquid crystal.

14. The method of claim 10, wherein the second state comprises a mirror mode.

15. The method of claim 10, wherein the first state comprises a video display mode.

16. A method of manufacturing a display unit, the method comprising:
providing a first absorptive polarizer;
arraying a first liquid crystal adjacent to the first absorptive polarizer;
arraying a second absorptive polarizer adjacent to the first liquid crystal, wherein the second absorptive polarizer is cross polarized with the first absorptive polarizer;
arraying a reflective polarizer adjacent to the second absorptive polarizer;
arraying a second liquid crystal adjacent to the reflective polarizer; and
arraying a third absorptive polarizer adjacent to the second liquid crystal, wherein the third absorptive polarizer is cross polarized with respect to the reflective polarizer.

17. The method of claim 16, comprising coupling a control system to the second liquid crystal, wherein the control system is configured to apply a voltage to the second liquid crystal to cause the display device to switch from a mirror mode to a video display mode.

18. The method of claim 16, wherein arraying a second liquid crystal adjacent to the reflective polarizer comprises arraying a single cell liquid crystal.

19. The method of claim 16, comprising a method for manufacturing a liquid crystal display television.

20. The method of claim 16, comprising coupling the first absorptive polarizer to a backlight.
